(19) United States
(12) Patent Application Publication
(10) Pub. No.: US 2014/0339251 A1
(43) Pub. Date: Nov. 20, 2014

(54) Refrigerated Dispensing Machine

(71) Applicant: Cub Pty Ltd, Southbank, VI (AU)

(72) Inventors: Travis Crothers, Southbank (AU); Doug Buckle, Southbank (AU); Jake Tankel, Southbank (AU); Lloyd Fenn, Southbank (AU); Larissa Morkous, Southbank (AU)

(73) Assignee: CUB PTY LTD, Southbank, VI (AU)

(21) Appl. No.: 14/357,660

(22) PCT Filed: Nov. 9, 2012
(86) PCT No.: PCT/AU2012/001386

§ 371 Date: May 12, 2014

(30) Foreign Application Priority Data
Nov. 10, 2011 (AU) 2011904694

(51) Int. Cl. G07F 11/34; G07F 9/10

(52) U.S. Cl. CPC G07F 11/34; G07F 9/105
USPC 221/150 R

(57) ABSTRACT

A refrigerated dispensing machine comprising: includes a refrigerated compartment having shelves adapted to hold items, and including a path along which the items can move through the refrigerated compartment to a dispensing outlet; a pick-up compartment located adjacent the dispensing outlet and separated from the refrigerated compartment by a door at the dispensing outlet; and a trigger that activates a release mechanism to dispense an item, wherein upon activation the release mechanism allows an item to dispense into the pick-up compartment and prevents a subsequent item from being dispensed.

The present invention relates to a dispensing machine for dispensing items, particularly refrigerated items such as beverage containers.

### BACKGROUND

Usually involving a transaction of currency or credit, vending machines dispense many types of items such as snacks, beverages including alcohol, cigarettes, and also non-perishable items. For perishables such as beverages that need to be refrigerated, the vending machine becomes more complex as refrigeration units and refrigeration compartments are introduced.

Items in vending machines are dispensed in a number of different ways. One common dispensing method involves stacking items in rows from the back of the vending machine to the front where a pushing mechanism behind the last item in the row pushes the row of items forward until the front item drops into a void and into a collection area. This technique is suitable for items that would not be damaged by the fall into the collection area or for items that are packaged well.

This technique is not suitable for items packaged in breakable materials, such as glass.

Vending machines are one type of machine that dispense items, and namely a machine that exchanges currency for the item. Dispensing machines however need not always take currency and may use similar dispensing mechanisms to a vending machine but without an exchange of currency. For example, such a dispensing machine may be suitable in a domestic or private environment where there is no need to exchange currency.

It is desired to provide a dispensing machine that can safely and reliably dispense refrigerated items.

### SUMMARY OF THE INVENTION

In accordance with the present invention there is provided a refrigerated dispensing machine comprising: a refrigerated compartment having shelves adapted to hold items, and including a path along which the items can move through the refrigerated compartment to a dispensing outlet; a pick-up compartment located adjacent the dispensing outlet and separated from the refrigerated compartment by a door at the dispensing outlet; and a trigger that activates a release mechanism to dispense an item, wherein upon activation the release mechanism allows an item to dispense into the pick-up compartment and prevents a subsequent item from being dispensed.

In a preferred embodiment the items are cylindrical in shape so that they can roll towards the dispensing outlet under gravity, and in a specific embodiment the items are cylindrical containers, such as beverage containers. Accordingly, the path to the dispensing outlet includes an inclined shelf adapted to hold items in a horizontal orientation so that the items can roll through to the dispensing outlet under gravity, and wherein the release mechanism holds the first item against rolling through the dispensing outlet, until activated.

Alternatively, where gravity is not relied upon to move items to the dispensing outlet, automated mechanisms such as mechanical arms or conveyors could be employed to move the items to the dispensing outlet.

In one embodiment of the machine, the release mechanism includes a movable guide that in a rest position abuts a first stop to prevent the guide moving and thereby obstructs an item from dispensing, but on activation by the trigger the guide clears abutment with the first stop to allow an item to move to the dispensing outlet. Releasing the trigger causes the guide to move back into abutment with the first stop.

In an embodiment a second stop prevents the guide from moving further than required to release only a specified number of items. In a preferred version only a single item is released and dispensed at any time.

The guide, in one embodiment, may be mounted on an axle that is connected to the trigger and capable of shifting axially against a bias when actuated by the trigger to clear the first stop. Preferably, the guide is mounted to rotate on the axle and has an arm that in the rest position blocks against dispensing of an item, and has an arm that in the rest position abuts against the first stop. Preferably, the guide has four arms and the guide rotates a quarter turn to dispense a single item. A return spring biases the guide back to the rest position. In one version, the release mechanism includes two guides moving in unison.

In an embodiment of the dispensing machine, the dispensing outlet may be sized and shaped to allow only correspondingly sized and shaped items to pass therethrough.

The dispensing machine may also include shelves that are ramped to follow the path and provide smooth rolling movement of the items. For example, the shelves could be open frames that allow circulation of air inside the refrigeration compartment.

The shelves may define a single path along which items can dispense towards the dispensing outlet, and namely the items are loaded in a single row. This is suitable where only one selection of item is required. However, where it is desired to offer selection of different types of items it would be suitable to provide separate and multiple racks for holding different selections of items, wherein the racks would lead into a single dispensing shelf that would lead the items to the dispensing outlet.

In one embodiment, the pick-up compartment is located below the dispensing outlet and has a curved and padded surface for receiving and guiding an item entering the pick-up compartment. The door at the dispensing outlet may be an insulated door that is biased to close the dispensing outlet.

In yet another embodiment, novelty features, such as an audio recording or flashing lights, may activate upon dispensing of an item.

### BRIEF DESCRIPTION OF THE DRAWINGS

An embodiment of the present invention will now be described by way of example with reference to the accompanying drawings, wherein:

FIG. 1 is a front view of a refrigerated dispensing machine in accordance with an embodiment of the present invention;

FIG. 2a is an angled view of the dispensing machine opened to show the internal components of the machine;

FIG. 2b is a front elevation view of the dispensing machine opened;

FIGS. 3a, 3b, 3c and 3d illustrate a sequence of steps showing a beverage container being dispensed into a pick-up compartment of the dispensing machine;

FIG. 4a is a plan view of a dispensing area in the dispensing machine;

FIG. 4b is an isometric view of a dispensing shelf in the dispensing area;

FIG. 4c is an end sectional view of a release mechanism in the dispensing area;

FIG. 4d is a perspective view of a trigger of the release mechanism;

FIGS. 5a, 5b, 5c and 5d are a sequence of steps illustrating a front view the release mechanism dispensing a beverage container; and

FIGS. 6a, 6b, 6c and 6d correspond respectively to

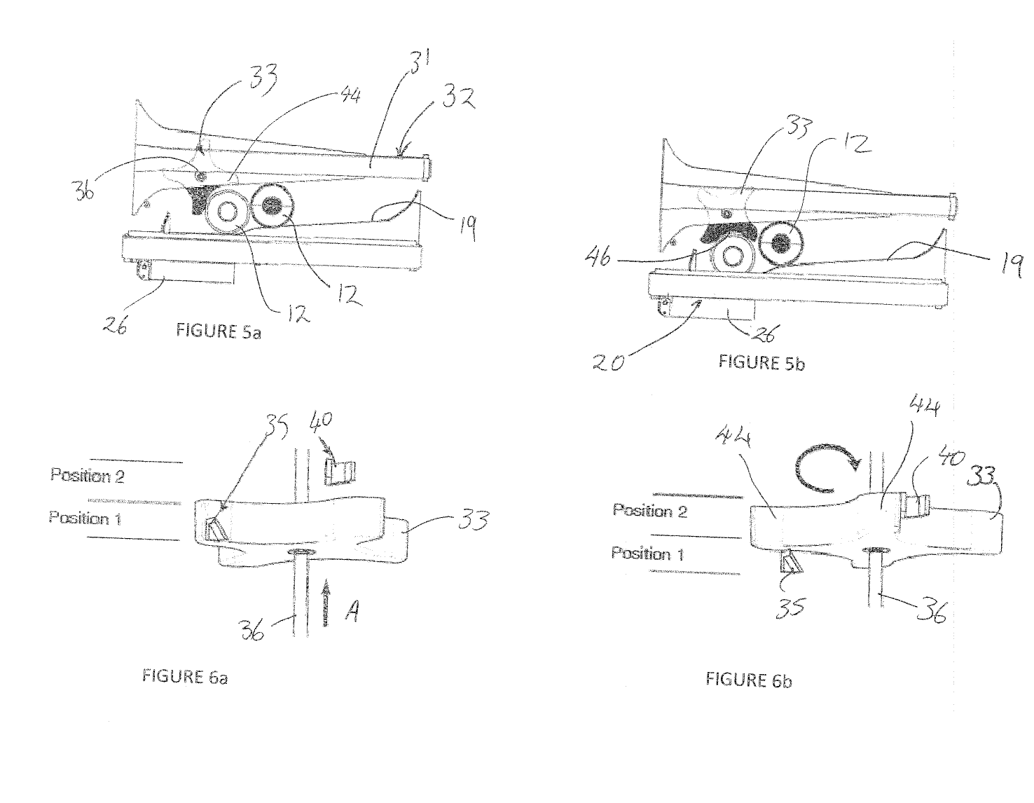

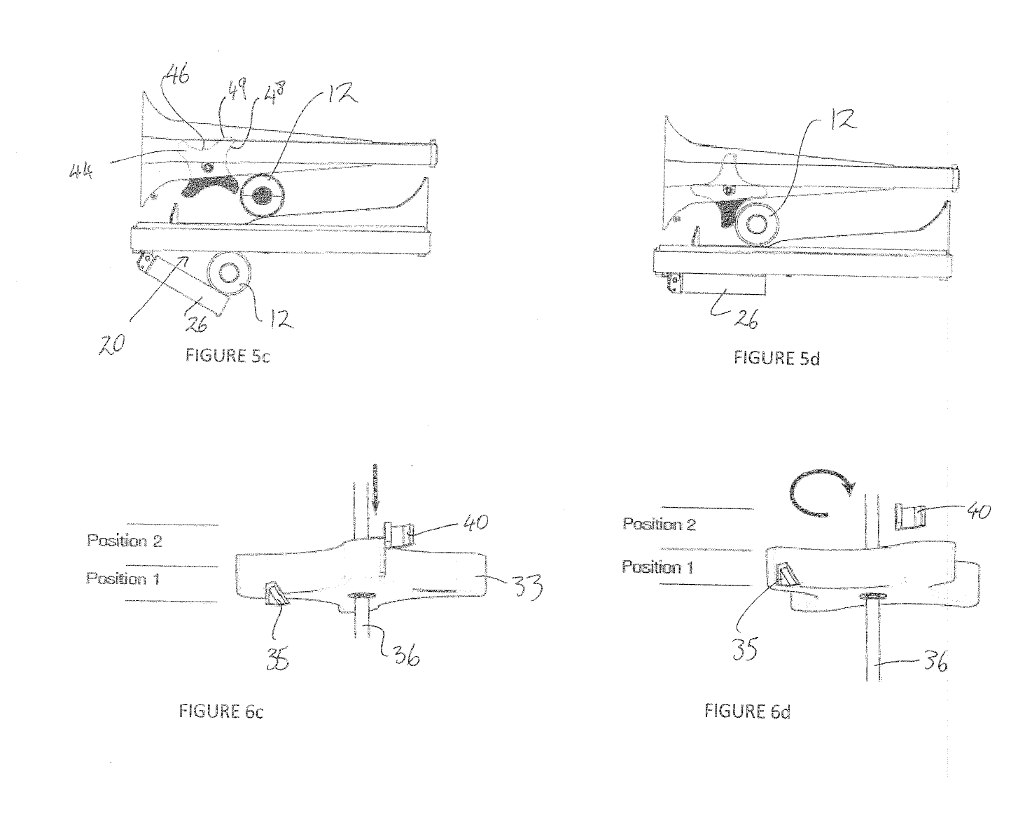

FIGS. 5a, 5b, 5c and 5d and illustrate from a plan view the position of a guide in a sequence of steps that correspond with FIGS. 5a, 5b, 5c and 5d.

### DETAILED DESCRIPTION OF EMBODIMENT

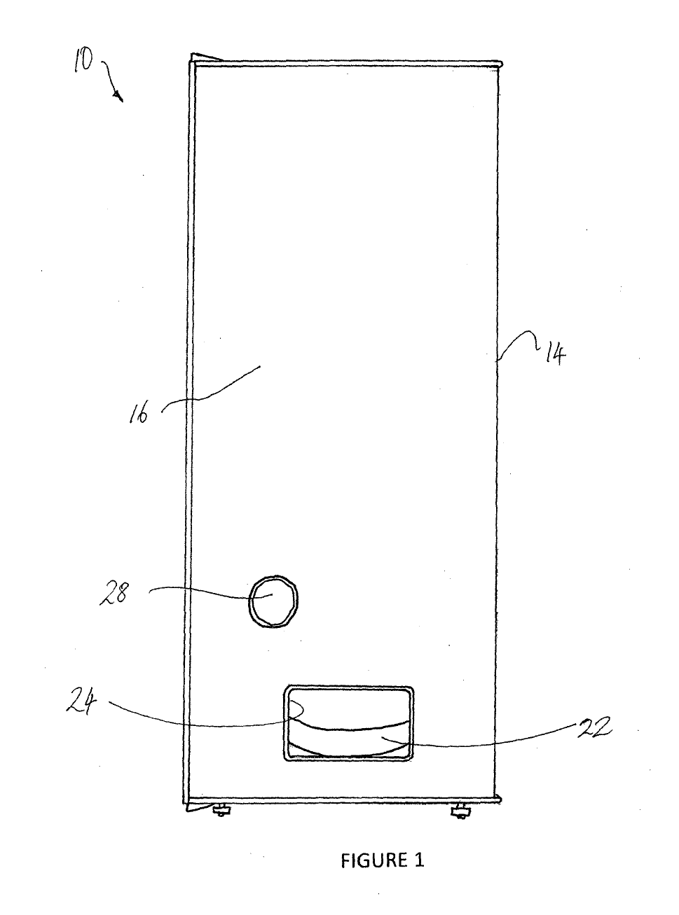

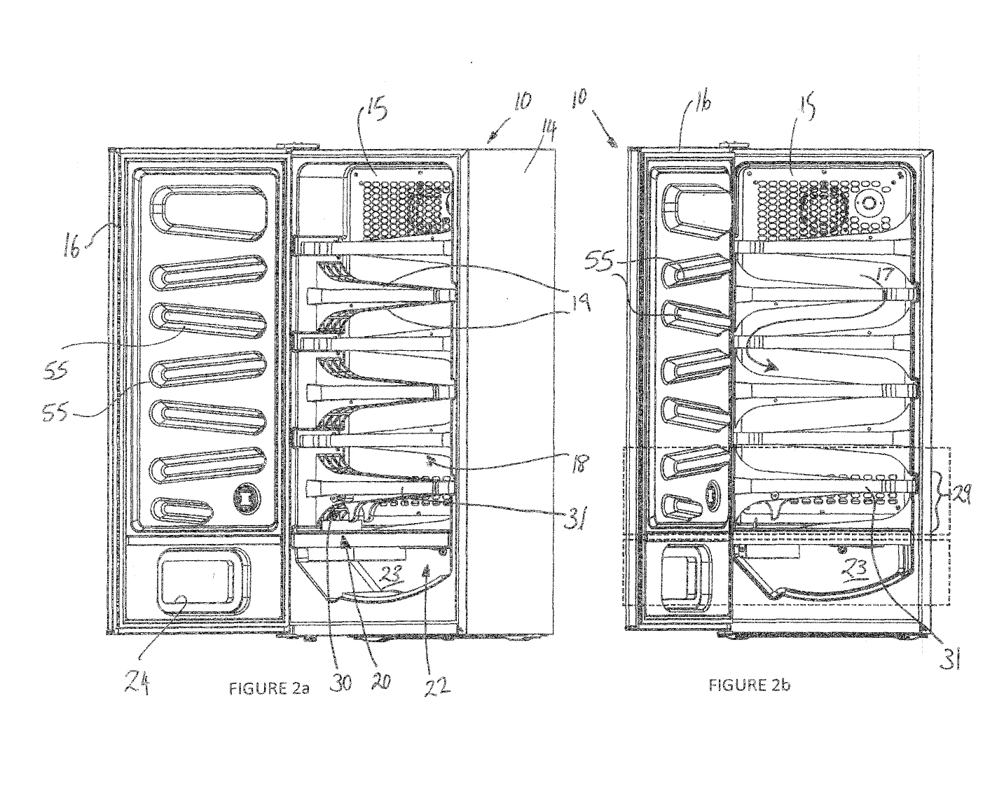

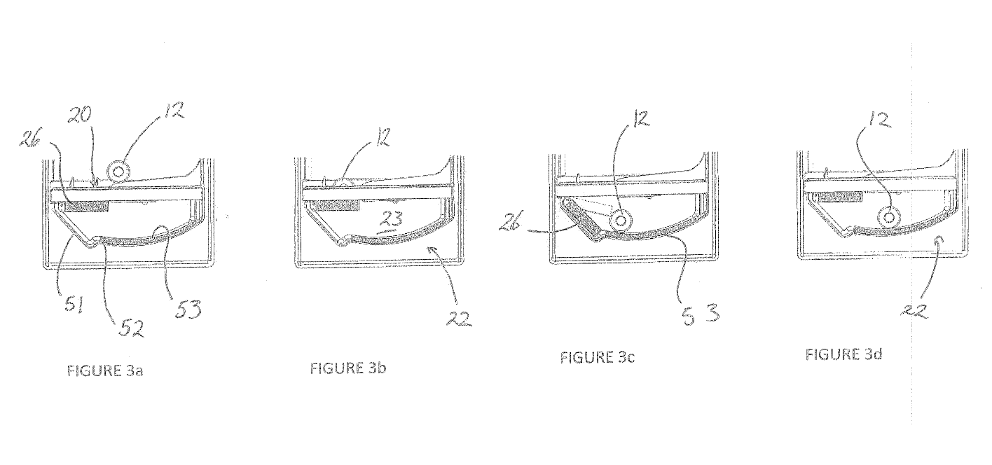

FIGS. 1, 2a and 2b illustrate a refrigerated dispensing machine 10 for storing items in refrigerated conditions and dispensing the items (as shown in sequence FIGS. 3a to 3d and FIGS. 5a to 5d).

The dispensing machine is in shape and form similar to known refrigeration units having a main outer body 14, a refrigeration system 15 and an insulated door 16 that closes onto the outer body to form a refrigerated compartment 18 inside the outer body 14 in which items to be refrigerated can be stored on shelves 19.

The embodiment of the dispensing machine 10 described herein is designed to dispense cylindrical items, or a like shape, that are capable of rolling under gravity. The items specifically described and illustrated herein are beverage containers 12. The beverage containers could be made of tin, plastic or glass and could contain, for example, soft drink, alcohol, etc. Reference to ‘beverage containers’ will be made throughout the description provided herein.

However, it is to be understood that as the concept of the invention includes within its scope embodiments where movement may occur using automated mechanisms, and not necessarily gravity, the containers to be dispensed need not necessarily be cylindrical in shape, or indeed, capable of rolling, but may be, for example, rectangular.

As discussed above, the dispensing machine 10 illustrated in the drawings is designed to hold beverage containers 12, such as soft drink cans and glass or plastics bottles containing alcoholic and non-alcoholic beverages and to dispense these containers in a reliable manner with minimal disturbance and agitation.

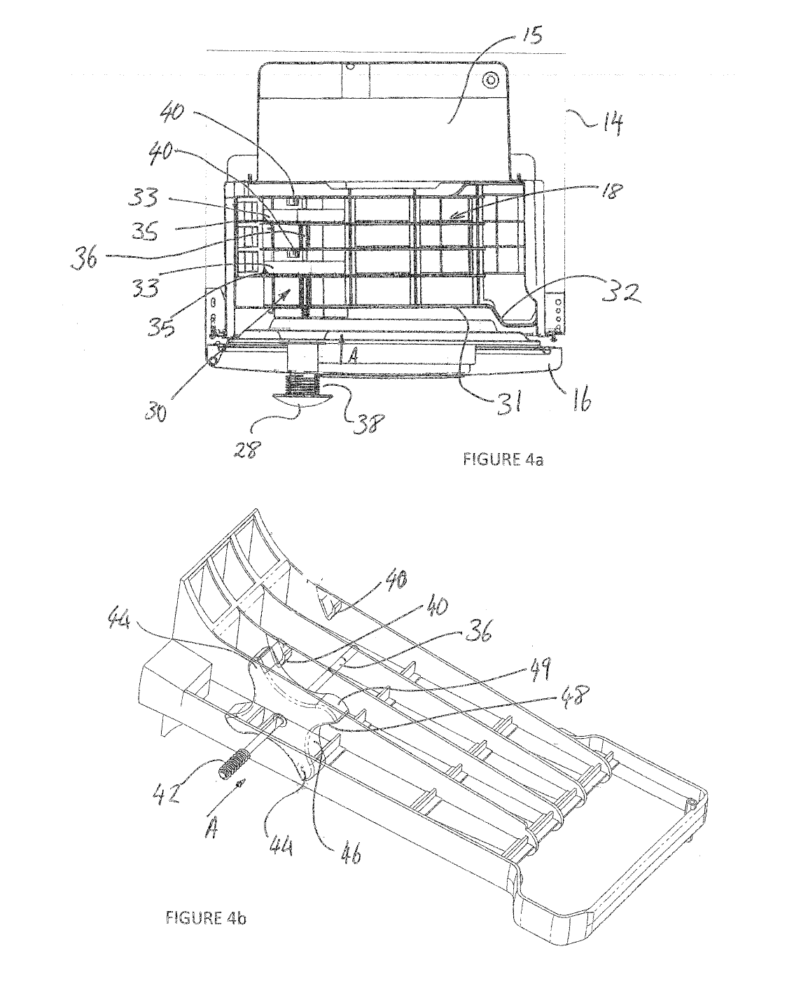

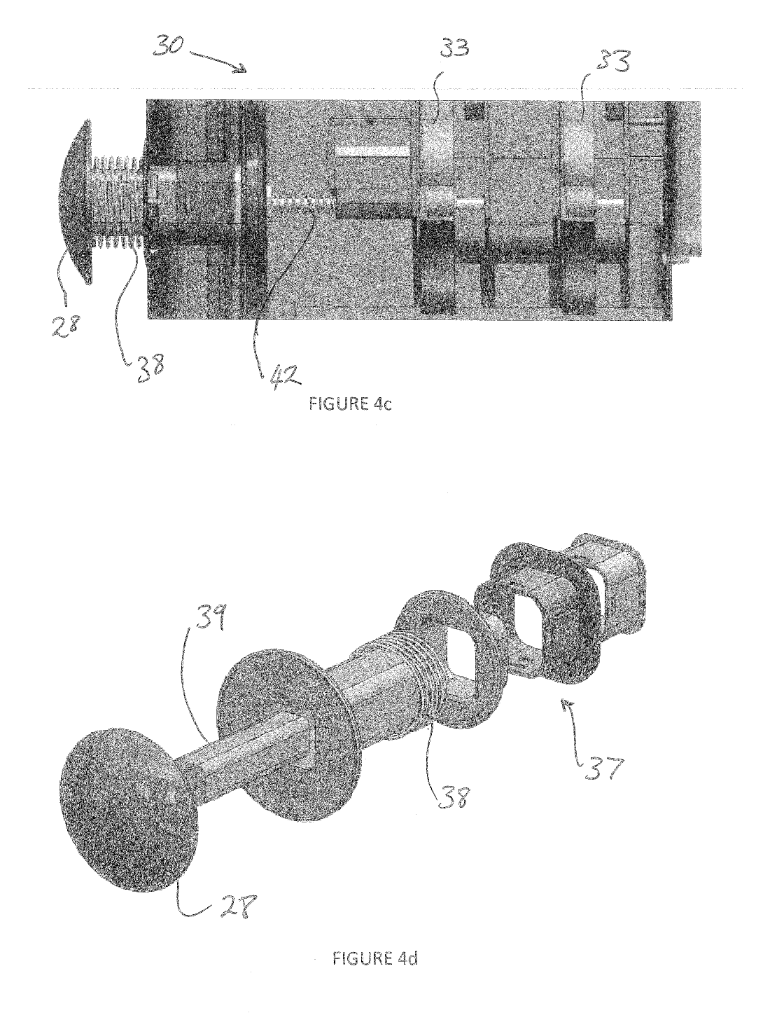

The beverage containers 12 are held on the shelves 19 in rows where the containers are horizontally-orientated and the shelving 19 is ramped and slightly inclined to encourage the containers to roll down along the shelving following a tortuous path 17 towards a dispensing outlet 20 located at a lower end of the refrigerated compartment 18. The shelves, as illustrated in FIG. 4b, are open frames, in this embodiment moulded from plastics, which while providing sufficient structure to support and smoothly guide a rolling container, also contain large openings to encourage circulation of refrigerated air throughout the refrigerated compartment 18 to ensure the contents of the dispensing machine 10 are properly and evenly refrigerated.

Beverage containers exiting the refrigerated compartment 18 through the dispensing outlet 20 enter a pick-up compartment 22 located adjacent the dispensing outlet. In the embodiment illustrated, the pick-up compartment is specifically located beneath the dispensing outlet. Pick-up compartment 22 is not refrigerated and has a collection area 23 from where a user can reach through a collection opening 24 in the door 16 and retrieve a dispensed beverage container.

As illustrated in FIGS. 3a to 3d, a trap door 26 at the dispensing outlet 20 is biased and insulated/sealed to keep the dispensing outlet closed until a rolling container approaches whereat the trap door opens under the weight of the container to dispense the container into the pick-up compartment 22.

A trigger, in the form of a button 28, is accessible from the front of the door 16. The button's mounting componentry including button shaft 39 and mounting plates 37 activate a release mechanism 30 to dispense a container from the refrigerated compartment 18 while preventing a subsequent container from being dispensed. The release mechanism is provided in a dispensing area 29 at the lower most end of the refrigerated compartment 18. FIG. 4b illustrates a dispensing shelf 31, and namely the last shelf along which a container rolls before dispensing, and which supports the release mechanism 30.

The release mechanism 30 acts to both hold the first, and lower most beverage container in a ready-to-dispense position and prevent it from rolling towards the trap door 26 at the dispensing outlet 20, as well as to release a beverage container upon activation of the trigger, or button. Upon release of the beverage container by the release mechanism, the beverage container enters the pick-up compartment 22. In the embodiment illustrated which involves a single path down which the containers roll, the release mechanism should be sufficiently strong to hold the weight of a refrigerated compartment fully stacked with beverage containers and yet allow only one beverage container to pass through to the dispensing outlet when the button 28 is activated. The release mechanism must also be able to function quickly to catch and retain the second container in line and prevent it from escaping past the release mechanism.

In its broadest form the release mechanism includes a movable container guide 33 that in a rest position is prevented from moving by abutting a first stop 35 and thereby obstructs a container from dispensing, but that on activation of the button 28, the guide 33 clears the first stop 35 to allow one container past the release mechanism to roll down to the dispensing outlet. Releasing the button causes the guide 33 to move back to the rest position and back into abutment with the first stop 35. The guide 33 is free to move as long as it is free of any stop and while it is free to move the guide allows passage through the release mechanism of a beverage container.

It is understood that in its broadest form that the trigger/button can cause either the guide to move clear of the first stop or alternatively the first stop to move clear of the guide, in order to release the guide from any restraint and allow it to be free to move to dispense beverage containers.

FIGS. 4a, 4b, 4c illustrate an embodiment of the release mechanism 30 described herein. In this embodiment the guide 33 is a rotatable member mounted on an axle 36 held in position by the dispensing machine housing, and specifically the dispensing shelf 31, although the axle 36 is free to move in an axial direction to shift laterally of the machine 10 and laterally of the direction of travel of the path 17 of the beverage containers. Axle 36 responds upon activation of the button 28 and specifically, pressing the button on the outside of the dispensing machine 10 causes the axle to shift axially and to thereby also shift the rotatable guide 33, which is mounted on the axle to only rotate.

The button 28 is designed to shift axle 36 against a bias which returns the button to the rest position. Specifically, the bias is a button spring 38 that biases button outwardly of the dispensing machine door 16 to keep the release mechanism 30 in a rest position where no other forces are acting on the release mechanism. However, when a force acts on the button 28, by way of a person pressing the button, the button shaft 39 pushes axle 36 to shift laterally. An exploded view of the button components is illustrated in FIG. 4(d).

The drawings illustrate two rotatable guides 33 mounted on axle 36. Each rotatable guide when in the rest position (as illustrated in FIG. 4c) abuts against the first stop 35 (see FIG. 4a). Shifting the axle 36 along the direction of arrow A in FIGS. 4a, 4b and 6a moves the guides towards an activation position away from first stop 35 to clear their abutment against the first stop and become free to rotate under the force of the first beverage container 12 in the row of beverage containers bearing down on the guides 33. Free rotational movement of the guides that are clear of the first stops 35 means the first container 12 can freely pass under the guides 33 and roll towards the dispensing outlet 20, through the trap door 26 and into the pick-up compartment 22. To prevent more than one beverage container being released a second stop 40 prevents free rotation of the guides 33 after the guide has rotated sufficiently far to allow one container to be dispensed. The second stop 40, similar to the first stop 35 is provided on the dispensing shelf 31 and in the embodiment shown, is specifically moulded with the shelf.

The second stop 40 is located close to the guide 33 and catches the guide after only a partial rotation to stop the second container in the row of containers from dispensing through the dispensing outlet with the first container. FIGS. 5a to 5d and 6a to 6d illustrate the relationship between the guide 33 and stops 35 and 45 in detail and will be explained further below.

It is understood that while the release mechanism 30 described herein is designed to release only one container at a time, minor modifications to the release mechanism and positioning of the stops 35, 40 could allow more than one container to pass through to the outlet at the same time, for example, two containers.

The button spring 38 returns the axle and guide(s) 33 back to the rest position allowing only a further small rotation of the guide before it comes into abutment with a first stop 35 where the formerly second container in the row now becomes the first container in the row to be dispensed. An axle spring 42 mounted on the axle 36 between the door 16 and shelf 19 assists in returning the release mechanism to the rest position.

The guide 33, or multiple guides 33 if more than one is used, comprises arms 44 that project outwardly from the main body of the guide so that the guide appears to be star-shaped. The arms 44 function to catch the guide against the first and second stops as well as retain containers from rolling down towards the dispensing outlet.

In the embodiment shown, the guides have four arms 44 that form a cross-shape, although fewer or more arms could be provided depending on the size of the release mechanism or the size of the containers to be dispensed and the movement of the guide relative to the position of the stops. The shape of the guides between the arms is curved and designed to correspond to the curvature of the beverage container so that a container can rest against a concave region 46 in the guide between the arms 44. The star-like shape of the guide with the concave region, aside from providing a barrier to container dispensation, when released smoothly and gently guides a beverage container past and below the release mechanism 30 without agitation or disturbance so that the container rolls smoothly down towards the dispensing outlet.

Each guide arm 44 is additionally shaped to encourage rolling of a container in one direction. Specially, one side of the arm has a flat face 48 designed to push and encourage a container towards the dispensing outlet, while the opposite side of each arm 44 has a convex curved face 49 that encourages the next container in line to slide into the concave region 46 and prevent dispensing of the second container.

The above described function of the release mechanism 30 is illustrated in FIGS. 5a to 5d and corresponding FIGS. 6a to 6d.

FIG. 5a illustrates a beverage container 12 ready to be dispensed. The release mechanism 30 is in the rest position. Container 12 rests in the concave region 46 in the guide 33. FIG. 6a illustrates the position of the guide 33 on axle 36 relative to first and second stops 35, 40 at the rest position of FIG. 5a.

When the button 28 is pushed from the outside of the dispensing machine 10 the button causes axle 36 to shift laterally, and hence guide 33 to shift laterally as illustrated in FIG. 6b to clear the guide arms 44 of the first stop 35. This allows the limited rotation of the guide 33 as illustrated in FIG. 5b which is sufficient to allow the first beverage container to pass under the guide and roll down inclined shelf 19 towards the dispensing outlet 20. At the same time, the arm 44 that has just cleared first stop comes into abutment with second stop 40 which catches the arm when the guide 33 is in its most shifted position as illustrated in FIG. 6b. Up to now the guide has rotated less than a quarter turn. It is understood that, however, the extent of rotation will depend on the number of arms provided on the guide and the position of the stops thereto.

FIG. 6c illustrates the instance where the button spring forces the release mechanism to move back to its rest position and the guide 33 to move back away from second stop 40 and back towards first stop 35. For a further brief amount of time the rotatable guide 33 is again free to move under the weight of one or more beverage containers bearing against it until the next guide arm 44 comes into abutment with the first stop 35.

It is noted that guide 33 has a width that is greater than the clearance distance between the first and second stops 35, 40 so that at no time is the guide ever free to continually rotate but will instead abut either the first stop 35 or the second stop 40. Indeed in an alternating order, either first stop 35 or second stop 40 will catch an arm 44 and stop the guide from rotating further.

FIG. 5c illustrates the guide 33 returning to its original rest position whereby a first beverage container 12 has already been dispensed through the dispensing outlet and the next container in line approaches the guide 33, bears against the guide 33 to rotate it further until it catches first stop 35 and nestles into the concave region 46, as illustrated in FIG. 5d. At this time the guide has stopped rotating. FIG. 6d illustrates a guide 33 returned to its rest position.

On approach towards the dispensing outlet 20, the force of the rolling container 12 rolling under gravity through the dispensing outlet 20 waits upon trap door 26 which opens to allow the beverage container 12 to enter the pick-up compartment. This process is illustrated by a sequence FIGS. 3a to 3d. The trap door 26 is biased towards the closed position to ensure that dispensing outlet 20 is kept closed all the time, to preserve the refrigerated temperatures of the refrigerated compartment 18, except when a container is being dispensed.

Trap door 26 can be biased towards a closed position by way of a suitable spring mechanism (not shown) or other suitable biasing mechanism. The spring mechanism ensures that the trap door 26 opens gently to allow dispensing of the container with minimal agitation or disturbance. Trap door 26 as illustrated in FIG. 3c opens to its maximum opening against a land 51 in the pick-up compartment 22. Land 51 follows the contour of the door 26 and includes an upwardly curved lip 52 that seamlessly allows container 12 to roll off the door 26 and onto a gently concaved ramp 53 that smoothly receives the container and allows it to roll in an oscillating movement backward and forward along the concave ramp 53 until it comes to a stop. Concave ramp 53 is lined with padding, such as foam to soften the impact of the dispensing container. The trap door 26 is similarly lined with soft padding to minimize agitation and shaking of the beverage inside the container.

The dispensing machine 10 described and illustrated herein does not accept currency to enable dispensing, although it is understood that simple known modifications to the machine 10 could be made to incorporate a currency and/or credit payment mechanism so that the trigger only operates once a payment is made.

In the version of the dispensing machine 10 illustrated in the drawings, only a specific beverage container having certain dimensions is able to be dispensed. FIG. 4b illustrates the dispensing shelf 31 having a dispensing opening 32 that allows containers to roll through to the lowermost shelf 19 before dispensing through the dispensing outlet 20 at the lower end of the refrigerated compartment 18 (see FIG. 5a). Dispensing opening 32 has a particular shape that allows only containers having a matching shape to pass through.

For example, the dispending opening 32 could be shaped to allow only squat “stubbie” bottles to roll through yet to prevent any bottles having a long neck from rolling through. Indeed, incorrectly shaped bottles would not be able to even be stacked in the refrigerated compartment 18 as they would either be too long to be horizontally positioned on the shelves 19 or they would fall foul of contoured projections 55 in the insulating foam on the inside of the machine door 16 (see FIGS. 2a and 2b). Projections 55 are designed to impede into the path 17 defined by the shelves and prevent the door 16 from closing if containers other than the correct short containers are loaded into the refrigerated compartment.

The features of the specifically-shaped shelf opening and the impeding projections provides a means for a person to provide beverage container dispensing machines that will only dispense containers suited to a specific shape. Other brand limiting means could be provided in the container to limit the brand/type of beverage container that can be dispensed. For example, a weigh station in the path 17 could measure the weight of each container and only allow it passage through to the dispensing outlet if it meets an allowed weight range.

Upon dispensing a beverage container, the dispensing machine 10 could be wired and programmed (through a processing unit in the machine) to activate novelty features for entertainment. The novelty feature could be triggered by the trap door opening, the button pressing, a sensor sensing a beverage container entering the pick-up compartment, or other trigger mechanism, and may comprise activating a sound or music, and/or illuminating a lighting effect on the machine, or any other form of visual, audio or other sensory entertainment.

In another possible variation of the dispensing machine, movement and transfer of the containers to the dispensing outlet may not occur under gravity but could be automated by mechanical means, such as robotic mechanisms used in known vending machines including 3-axis movement transport platforms or conveyors. In those embodiments the presently described concept of dispensing beverage containers through a dispensing outlet by use of a release mechanism would still apply, but may apply to items that are not capable of rolling, or where rolling of the item is undesirable.

Other variations to the concept include providing more than one path along which the containers can travel to the dispensing outlet. This is useful where, for example, a variety of beverage containers is offered and the user can select one variety that the release mechanism will release while preventing release of other varieties. In this embodiment the release mechanism could have multiple guides mounted axially, each guide corresponding to a separate row of containers, wherein each row corresponds to a different variety of beverage. The release mechanism be operable along its axle to only allow one guide to rotate to dispense a container from the row of the selected beverage.

The present beverage container dispensing machine can be adapted to be used with any type of alcoholic or non-alcoholic beverage container to provide a reliable means of storing and refrigerating beverage containers and then when activated dispensing one container at a time in response to a trigger, while ensuring that when the beverage container is dispensed, dispensing occurs as smoothly and as guided as possible, avoiding any sharp or sudden drops that could shake the beverage inside the container.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A refrigerated dispensing machine comprising:
a refrigerated compartment having shelves adapted to hold items, and including a path along which the items can move through the refrigerated compartment to a dispensing outlet;
a pick-up compartment located adjacent the dispensing outlet and separated from the refrigerated compartment by a door at the dispensing outlet; and
a trigger that activates a release mechanism to dispense an item, wherein upon activation the release mechanism allows an item to dispense into the pick-up compartment and prevents a subsequent item from being dispensed.

2. The refrigerated dispensing machine claimed in claim 1, wherein the path to the dispensing outlet includes an inclined shelf adapted to hold cylindrical items in a horizontal orientation so that the items can roll through to the dispensing outlet under gravity, and wherein the release mechanism holds the first item against rolling through the dispensing outlet.

3. The refrigerated dispensing machine claimed in claim 1 or 2, wherein the release mechanism includes a movable guide that in a rest position abuts a first stop to prevent the guide moving and thereby obstructs an item from dispensing, but on activation by the trigger the guide clears abutment with the first stop to allow an item to move to the dispensing outlet.

4. The refrigerated dispensing machine claimed in claim 3, wherein the trigger is biased to move the guide back into abutment with the first stop.

5. The refrigerated dispensing machine claimed in claim 3 or claim 4, wherein the release mechanism includes a second stop that prevents the guide from moving further than required to release a specified number of items.

6. The refrigerated dispensing machine claimed in claim 5, wherein only a single item is released at any time.

7. The refrigerated dispensing machine claimed in any one of claims 3 to 6, wherein the guide is mounted on an axle that is connected to the trigger and capable of shifting axially against a bias when actuated by the trigger to clear the first stop.

8. The refrigerated dispensing machine claimed in any one of claims 3 to 7, wherein the guide is a rotatable member mounted to rotate on an axle.

9. The refrigerated dispensing machine claimed in claim 8, wherein the guide has an arm that in the rest position blocks against dispensing of an item and has an arm that in the rest position abuts against the first stop.

10. The refrigerated dispensing machine claimed in claim 8 or 9, wherein the guide has four arms and the guide rotates a quarter turn to dispense a single item.

11. The refrigerated dispensing machine claimed in any one of claims 3 to 10, wherein the release mechanism includes two guides mounted on the same axle and moving in unison.

12. The refrigerated dispensing machine claimed in any one of the preceding claims, wherein the dispensing outlet is sized and shaped to allow only correspondingly sized and shaped items to pass therethrough.

13. The refrigerated dispensing machine claimed in any one of the preceding claims, wherein the shelves define a single path, or multiple paths, to the dispensing outlet and are ramped to follow the path and provide smooth rolling movement of the items.

14. The refrigerated dispensing machine claimed in any one of the preceding claims, wherein the shelves are open frames that allow circulation of air inside the refrigeration compartment.

15. The refrigerated dispensing machine claimed in any one of the preceding claims, wherein the pick-up compartment is located below the dispensing outlet and has a curved and padded surface for receiving and guiding an item entering the pick-up compartment.

16. The refrigerated dispensing machine claimed in any one of the preceding claims, wherein the door at the dispensing outlet is an insulated door that is biased to close the dispensing outlet.

17. The refrigerated dispensing machine claimed in any one of the preceding claims, wherein novelty features activate on dispensing of an item.
